(19) United States
(12) Patent Application Publication
(10) Pub. No.: US 2024/0321094 A1
(43) Pub. Date: Sep. 26, 2024

(54) Hands-Free Device and System for Real Time Notifications for Runaway Ramps and Exits

(71) Applicants: Jose Arrieta, Golden, CO (US); Candy Olivarri-Arrieta, Golden, CO (US)

(72) Inventors: Jose Arrieta, Golden, CO (US); Candy Olivarri-Arrieta, Golden, CO (US)

(21) Appl. No.: 18/610,454

(22) Filed: Mar. 20, 2024

Related U.S. Application Data
(60) Provisional application No. 63/491,544, filed on Mar. 22, 2023.

(51) Int. Cl. G08G 1/0967; G08G 1/01; G08G 1/09

(52) U.S. Cl. CPC G08G 1/096783; G08G 1/0112; G08G 1/0116; G08G 1/091

(57) ABSTRACT

A safety device for trucks or vehicles that helps drivers identify and locate approaching runaway truck ramps and exits while driving. The device receives real-time signals from sensors positioned on sign posts when the vehicle approaches and/or passes the sign posts, which are then converted into audio signals and preconfigured natural language by the processor and language translation module, respectively. A speaker of the device plays out the audio to provide a warning or information to the driver. The device is hands-free and does not distract the driver, thereby improving security for the driver and the vehicle. The device can be a part of a safety system wherein the sensors and the device communicate via a V2I communication channel. The device can also communicate with emergency systems and fleet management systems.

### CROSS-REFERENCE TO RELATED APPLICATION

The present application claims priority to, and the benefit of, U.S. Provisional Application No. 63/491,544, which was filed on Mar. 22, 2023, and is incorporated herein by reference in its entirety.

### FIELD OF THE INVENTION

The present invention generally relates to the field of vehicular safety devices. More specifically, the present invention relates to a novel safety system and transmitter device for promoting safety in the trucking industry and helps save lives. The device is mounted inside a vehicle such as a truck for receiving information about approaching runaway truck ramps, exits from sensors positioned on truck ramp signs when the vehicle passes through them. The device provides the information to driver in an audio format. Accordingly, the present disclosure makes specific reference thereto. Nonetheless, it is to be appreciated that aspects of the present invention are also equally applicable to other like applications, devices, and methods of manufacture.

### BACKGROUND

By way of background, runaway truck ramps and exits are designed to provide an escape route for drivers of large vehicles such as tractor-trailers or buses in case of an emergency, such as a brake failure or other malfunction that may cause the vehicle to become uncontrollable. Runaway truck ramps and exits provide a vital safety measure for drivers of large vehicles, especially those who travel through steep or hilly terrain. Runaway truck ramps and exits can also provide peace of mind for drivers who know that they have a safe place to pull off the road in case of an emergency. Further, by directing large vehicles to these ramps and exits, traffic can be better managed, especially during times of heavy traffic or accidents.

However, without proper and automatic notification of approaching runaway ramps or exits, drivers may be unaware of where they can safely pull off in case of an emergency. This can cause devastating damage and can be fatal for driver and other individuals. Further, manually checking for approaching exits can distract drivers from driving and increase the risk of an accident. Additionally, traffic information may be required by drivers in order to make informed decisions about their route, but this information is not always readily available. In order to mitigate these risks, automatic identification of runaway truck ramps and exits without distracting drivers is essential.

Therefore, there exists a long felt need in the art for a safety system that promotes safety in the trucking industry and helps save lives. There is also a long felt need in the art for a safety device that provides automatic notifications to drivers of approaching runaway ramps and exits. Additionally, there is a long felt need in the art for a safety device and system that eliminates manual checking of approaching runaway ramps and exits by drivers. Moreover, there is a long felt need in the art for a mechanism that prevents a driver from missing runaway truck ramps, exits, and helps to avoid roadway congestion. Further, there is a long felt need in the art for a safety device that provides hands-free information to drivers about runaway truck ramps, exits and more. Finally, there is a long felt need in the art for safety system that uses sensors on truck ramp signs for providing signals to a vehicular device about approaching runaway truck ramps and exits.

The subject matter disclosed and claimed herein, in one embodiment thereof, comprises a safety system for notifying drivers of trucks about approaching runaway truck ramps and exits. The safety system further comprising a truck talk safety device installed inside a vehicle, preferably near a windshield of the vehicle, the safety device is configured to provide information in an audio format to the driver of the vehicle about approaching runaway truck ramps and exits, one or more truck ramp sign sensors positioned on the truck ramp signs installed on the highways, the ramp sign sensors preconfigured with nearby runaway truck ramps and exits information and configured to send information signals to the truck talk safety device via a wireless communication channel for providing information to the drivers when the vehicle passes through the truck ramp signs.

In this manner, the safety system and associated truck talk safety device of the present invention accomplish all of the forgoing objectives and provide truck drivers with a transmitter device mounted to the inside of a windshield in a cab or on the dashboard of a vehicle for situational and roadway awareness. The system prevents a driver from missing runaway truck ramps/exits and helps to avoid roadway congestion and traffic accidents.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a safety system for notifying drivers of trucks about runaway truck ramps and exits. The safety system further comprising a truck talk safety device installed inside a vehicle, the talk safety device mounted on a windshield or dashboard of the vehicle and configured to provide information in an audio format to the driver of the vehicle about approaching runaway truck ramps and exits, one or more truck ramp sign sensors positioned on the truck ramp signs installed on the highways, the ramp sign sensors preconfigured with nearby runaway truck ramps and exits information and configured to send information signals to the truck talk safety device via a wireless communication channel for providing information to the drivers.

In yet another embodiment, the wireless communication channel uses any V2I communication that allows for wireless data exchange between vehicles and sensors.

In a further embodiment, a truck talk safety transmitter device for providing information to a driver of a vehicle about approaching runaway truck ramps, exits, and traffic information is disclosed. The device is designed to be mounted inside a vehicle such as a truck and further comprising a power source configured to provide electric power to the device, a wireless transceiver configured to establish V2I communication with one or more sensors positioned on truck ramp sign posts, an integrated speaker configured to provide audible alerts and warnings to a driver based on the information received from the sensors, a processor configured to process information signals received from the sensors and coupled to a language translation module for translating messages into one or more languages, and a microphone configured to receive a driver's voice and an integrated voice recognition module configured to process the driver's voice captured by the microphone and converting it into digital data that can be processed by the processor.

In a further embodiment, the truck talk safety transmitter device further includes a rugged and weatherproof housing, a fastener for mounting the housing near a windshield of the vehicle, a connecting wire for coupling the device with electrical network of the vehicle, an LED disposed on the housing of the device for indicating the status of the device, wherein a red color indication indicates a malfunctioning of the device and a green color indication indicates the device is working properly.

In yet another embodiment, a method for providing hands-free warnings and information about approaching runaway truck ramps, exits, and traffic information to a driver of a vehicle is described. The method includes the steps of installing and configuring a truck talk safety device, receiving a real-time signal from one or more sensors positioned on a truck ramp sign post as the vehicle passes through the sign post, wherein the signal includes at least one of location of the next ramp exit and traffic information, converting the received signals from the one or more sensors into audio signals using a processor of the device, translating the audio signals into a preconfigured natural language for understanding by a driver using a language translation module, and playing out the audio signals using a speaker for providing warnings or information to the driver, without distracting the driver.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a truck driver safety system of the present invention in accordance with the disclosed architecture;

FIG. 2 illustrates a functional block diagram of the truck talk safety device used for communicating information to a driver in accordance with the disclosed architecture;

FIG. 3 illustrates a perspective view showing the truck talk safety device mounted inside a truck in accordance with the disclosed architecture;

FIG. 4 illustrates a schematic view showing the communication of the truck talk safety device mounted inside a vehicle with emergency services and fleet management system in accordance with the disclosed architecture;

FIG. 5 illustrates a flow diagram depicting installation and configuration of the transmitter device used in safety system in accordance with the disclosed architecture;

FIG. 6 illustrates another flow diagram depicting the working of the transmitter device is disclosed in accordance with the disclosed architecture; and

FIG. 7 illustrates a rear perspective view of the truck talk safety device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a safety system that promotes safety in the trucking industry and helps save lives. There is also a long felt need in the art for a safety device that provides automatic notifications to drivers of approaching runaway ramps and exits. Additionally, there is a long felt need in the art for a safety device and system that eliminates manual checking of approaching runaway ramps and exits by drivers. Moreover, there is a long felt need in the art for a mechanism that prevents a driver from missing runaway truck ramps, exits, and helps to avoid roadway congestion. Further, there is a long felt need in the art for a safety device that provides hands-free information to drivers about runaway truck ramps, exits and more. Finally, there is a long felt need in the art for safety system that uses sensors on truck ramp signs for providing signals to a vehicular device about approaching runaway truck ramps/exits.

The present invention, in one exemplary embodiment, is a method for providing hands-free warnings and information about approaching runaway truck ramps, exits, and traffic information to a driver of a vehicle. The method includes the steps of installing a truck talk safety device, receiving a real-time signal from one or more sensors positioned on a truck ramp sign post as the vehicle passes through the sign post, wherein the signal includes at least one of location of the next ramp exit and traffic information, converting the received signals from the one or more sensors into audio signals using a processor of the device, translating the audio signals into a preconfigured natural language for understanding by a driver using a language translation module, and playing out the audio signals using a speaker for providing warnings or information to the driver, without distracting the driver.

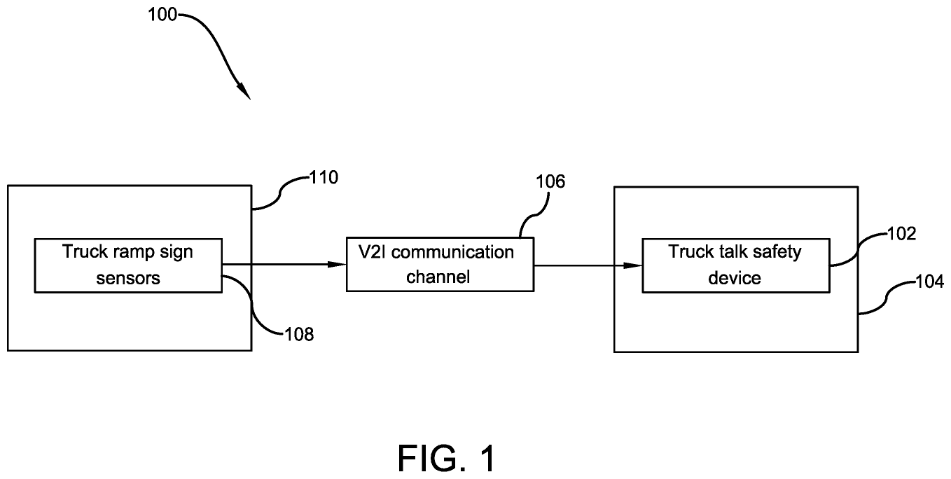

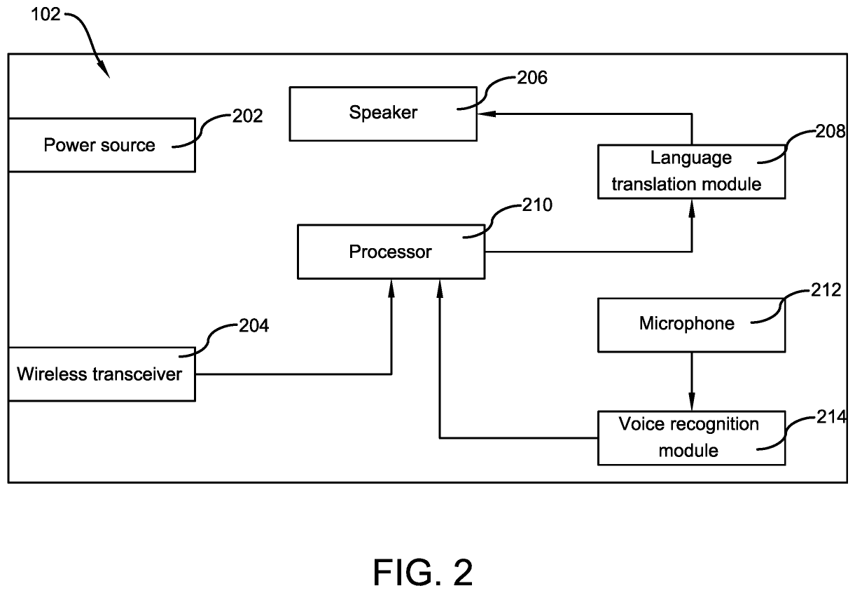

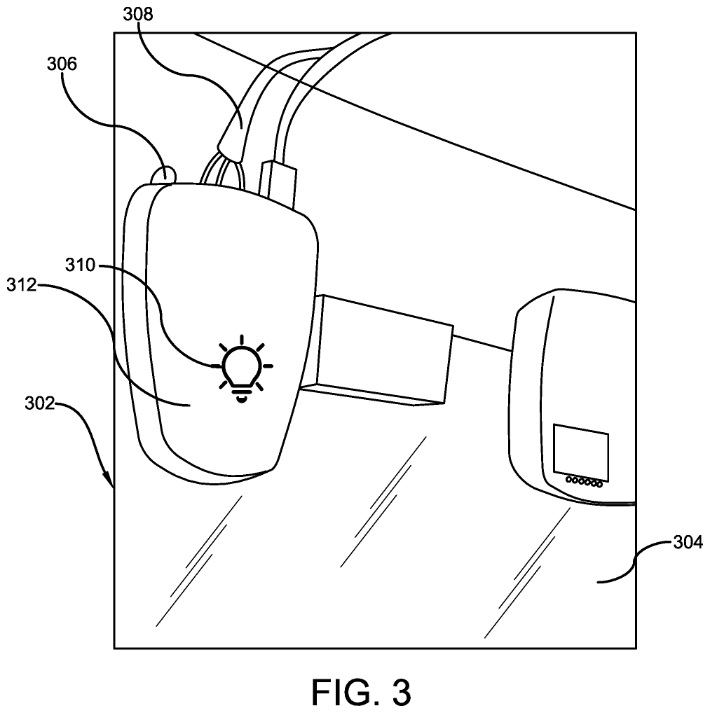

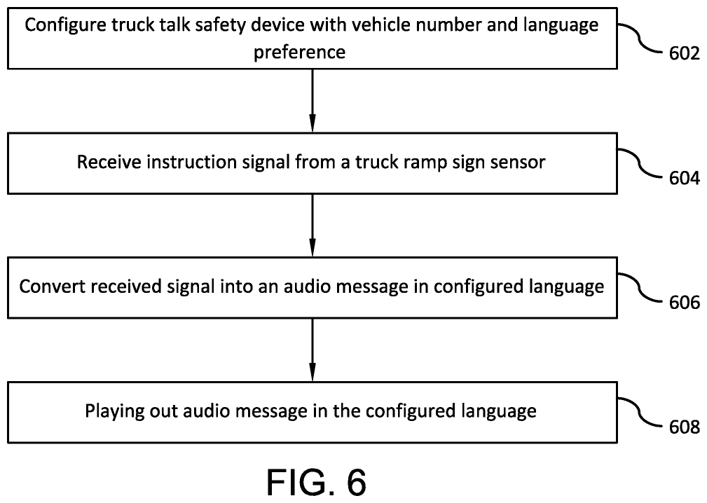

Referring initially to the drawings, FIG. 1 illustrates a perspective view of one potential embodiment of the truck driver safety system of the present invention in accordance with the disclosed architecture. The safety system 100 of the present invention is designed to notify drivers of vehicles such as trucks about runaway truck ramps/exits, and helps to avoid roadway congestion and accident traffic. More specifically, the safety system 100 includes a novel truck talk safety device 102 installed inside a vehicle 104 for transmitting information to a driver. The truck talk safety device 102 is preferably mounted to the inside of a windshield in a cab or on the dashboard of a vehicle for prevention from weather elements as illustrated in FIG. 3. The truck talk safety device 102 provides information in an audio format to the driver of a vehicle about approaching runaway truck ramps and exits as described in FIGS. 2 and 6.

The truck talk safety device 102 communicates with one or more truck ramp sign sensors 108 positioned on the truck ramp signs 110 installed on the highways via a wireless communication channel 106. The sensors 108 are preconfigured with the nearby runaway truck ramps and exits information and are designed to send information signals to the truck talk safety device 102 for providing information to the drivers. The wireless communication channel 106 can be any V2I communication channel which allows for wireless data exchange between vehicles and roadside infrastructure. The wireless communication channel 106 can be any wireless communication technologies, including but not limited to Dedicated Short Range Communications (DSRC), Cellular Vehicle-to-Everything (C-V2X), and Wi-Fi. Using V2I communication, truck ramp sign sensors 108 can also transmit real-time information about traffic flow, signal timings, and other relevant data to truck talk safety device 102. In the preferred embodiment, 5.9 GHZ frequency band is used that allows for high-speed, low-latency communication between the truck talk safety device 102 and the sensors 108.

In the system 100, each truck ramp sign along highways can include one or more sensors 108 such that when a commercial truck driver approaches the sign 110, one or more sensors 108 send a signal to the truck talk safety device 102 about approaching ramps, exits, and other traffic information. This prevents a driver from missing runaway truck ramps, exits, and helps to avoid roadway congestion and promotes safety in the trucking industry and helps save lives.

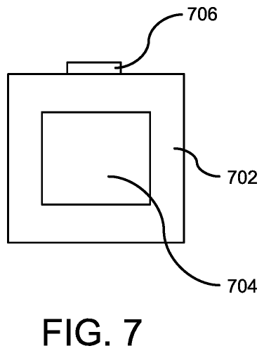

FIG. 2 illustrates a functional block diagram of the truck talk safety device 102 used for communicating information to a driver in accordance with the disclosed architecture. The device 102 uses a power source 202 for providing electric power to the device 102 necessary for the functioning thereof. The power source 202 can be either a removable and replaceable battery positioned inside the device 102 or alternatively, the device 102 can be hardwired to the truck's electrical system using a connector as illustrated in FIG. 3. The battery is preferably Li-Ion battery and can be rechargeable. Further, the battery 202 can be recharged using a USB port or dedicated charging dock as illustrated in FIG. 7. The device 102 can receive power from the electrical system of the vehicle, wherein the power source can be one of the truck's battery, alternator, or any other power source that can supply a constant DC voltage to the device 102.

For establishing V2I communication with one or more sensors 108 as illustrated in FIG. 1, the device 102 has a wireless transceiver 204. The wireless transceiver 204 can also establish Bluetooth Low Energy (BLE), Wi-Fi, or cellular networks for effective communication. The specific power source 202 and wireless transceiver 204 used in the truck talk safety transmitter device 102 can depend on the specific requirements of the device 102, such as its range, power consumption, and data transfer rate.

An integrated speaker 206 is disposed in the device 102 for providing audible alerts and warnings to a driver based on the information received from the sensors 108. The speaker 206 can be any type of conventional speaker such as a piezoelectric speaker. Preferably, the speaker 206 playout the warning or alert in a natural language preconfigured in the device 102 using the language translation module 208. During configuration of the device 102, a preferred language understood by a driver can be pre-configured in the device 102 for playing out warning messages for the driver.

A processor 210 is configured for processing the information signals received from the sensors 108. Further, the processor 210 is coupled to the language translation module 208 for sending the message to the module 208 for translating into a pre-configured language. The processor 210 also includes machine learning algorithms for providing advanced warning messages based on interpretation of the received signals from the sensors 108. In some embodiments of the present invention, the processor 210 is coupled to a cloud storage for updating and supervising the machine learning algorithms. The processor 210 may include, but not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), a microcontroller and the like. The language translation module 208 is configured to perform natural language processing for translating messages into one or more languages.

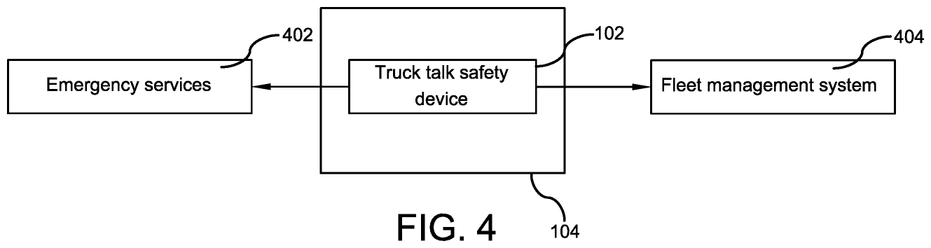

For enabling a driver to access emergency systems or other fleet members as illustrated in FIG. 4, the device 102 has a microphone 212 for receiving a driver's voice. The microphone 212 is preferably a noise-cancelling microphone that filters out background noise and other sources of interference. The microphone 212 is oriented towards the driver's seat for effectively capturing driver's audio. An integrated voice recognition module 214 is responsible for processing the driver's voice captured by the microphone 212 and converting it into digital data that can be processed by the device's processor 210.

FIG. 3 illustrates a perspective view showing the truck talk safety device 102 mounted inside a truck in accordance with the disclosed architecture. The safety device 102 is mounted inside the vehicle 302, preferably near the windshield 304 using a fastener 306. The fastener 306 helps in mounting the device 102 securely without any physical damage. A connecting wire 308 is used for coupling the device 102 with the electrical network of the vehicle 302 for providing electric power to the device 102. A LED 310 is disposed on housing 312 of the device 102 for indicating the status of the device 102. In one exemplary embodiment, a red color indicator in the LED 310 indicates a malfunctioning in the device 102 whereas a green color indicator indicates that the device 102 is working fine. The housing 312 is rugged, weatherproof, and protects the internal components illustrated in FIG. 2 from physical damage.

Further, the device 102 can be installed in the vehicle 302 during manufacturing of the vehicle 302 or can also be retrofitted as an aftermarket product by vehicle owners for their safety.

FIG. 4 illustrates a schematic view showing the communication of the truck talk safety device mounted inside a vehicle with emergency services and fleet management systems in accordance with the disclosed architecture. The transmitter device 102 using the wireless transceiver 204 communicates with an emergency service 402. In the event of an emergency, the driver can speak into microphone 212 or in some embodiment, the device 102 takes input from the vehicle's sensors for triggering the device 102 to send a signal to the emergency services 402. Further, in situations where the device 102 provides a warning message to the driver through the speaker 206, an instruction signal is automatically sent to the connected emergency services 402 by the device 102.

The transmitter device 102 can also communicate with a fleet management system 404. This helps a fleet manager to track the location of the vehicle in real-time, monitor its speed and other parameters, and receive alerts if any issues arise. In some embodiments of the present invention, the device 102 can also be programmed to send alerts to the fleet manager if the driver is speeding, driving erratically, or engaging in other risky behaviors.

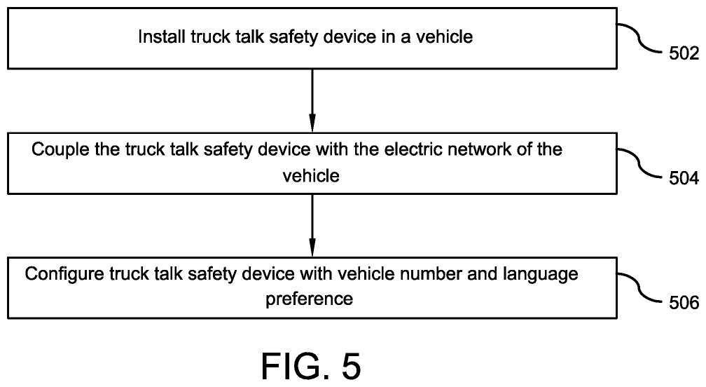

FIG. 5 illustrates a flow diagram depicting installation and configuration of the transmitter device used in safety system in accordance with the disclosed architecture. Initially, the truck talk safety device is physically installed in the vehicle, preferably inside of the windshield or dashboard (Step 502). The installation process can vary depending on the specific vehicle, but typically involves attaching the device 102 securely using a fastener to the vehicle's interior and connecting it to the vehicle's power source. Then, the truck talk safety device 102 is coupled with the electric network of the vehicle for allowing the safety device 102 to receive signals from vehicle's sensors and receiving electrical power from the vehicle (Step 504). Once, the device 102 is successfully installed and connected to the vehicle, then, the safety device 102 is configured with a vehicle number such as license number of the vehicle in which the device 102 is installed and language preference is selected in which the speaker 206 plays out the audio output for the driver of the vehicle (Step 506).

Referring to FIG. 6, another flow diagram depicting the working of the transmitter device 102 is disclosed in accordance with the disclosed architecture. Initially, the truck talk safety device 102 is configured as illustrated in Step 506 of the FIG. 5 (Step 602). Then, as the truck or vehicle passes through a truck ramp sign post 110, the truck talk safety device 102 receives a real time signal from one or more sensors 108 positioned on the sign post 110 wherein the instruction signal can indicate location of next ramp exit, traffic information and more (Step 604). Then, the processor 210 of the transmitter device 102 converts the received signals from the sensors 108 into audio signals and the language translation module 208 converts the audio into preconfigured natural language for understanding by a driver (Step 606). Finally, the speaker 206 plays out the audio for providing warning or information to the driver (Step 608). It should be noted that operation of the device 102 is hands-free and therefore, does not distract the driver, thereby improving security of the driver and the vehicle.

FIG. 7 illustrates a rear perspective view of the truck talk safety device 102 of the present invention in accordance with the disclosed architecture. As illustrated, the rear surface 702 of the device 102 has a battery socket 704 for housing the battery of the device 102. Further, the device 102 has a USB port 706 for connecting the device 102 to electric supply of the vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “truck driver safety system”, “safety system”, and “system” are interchangeable and refer to the safety system 100 of the present invention. Similarly, as used herein “transmitter device”, “device”, and “truck talk safety device” are interchangeable and refer to the truck talk safety transmitter device 102 of the present invention.

Notwithstanding the forgoing, the truck driver safety system 100 and the truck talk safety transmitter device 102 of the present invention can be of any suitable size and configuration as is known in the art without affecting the overall concept of the invention, provided that it accomplishes the above stated objectives. One of ordinary skill in the art will appreciate that the truck driver safety system 100 and the truck talk safety transmitter device 102 as shown in the FIGS. are for illustrative purposes only, and that many other sizes and shapes of the truck driver safety system 100 and the truck talk safety transmitter device 102 are well within the scope of the present disclosure. Although the dimensions of the truck driver safety system 100 and the truck talk safety transmitter device 102 are important design parameters for user convenience, the truck driver safety system 100 and the truck talk safety transmitter device 102 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety system to notify drivers of runaway truck ramps and exits, the safety system comprising:
a truck talk safety device for transmitting information to a driver;
wherein said truck talk safety device is mounted to an inside of a cab of a truck;
wherein said truck talk safety device having an audio format for providing information to the driver;
wherein said information includes notice of approaching runaway truck ramp/exit;
wherein said truck talk safety device communicates with one or more truck ramp sign sensors positioned on truck ramp signs installed on the highways via a wireless communication channel;
wherein said truck ramp sign sensors including a runaway truck ramp/exit information signal and sends said information signal to said truck talk safety device for providing said information signal to the driver; and
further wherein said truck ramp sign sensors having a plurality of said truck ramp sign sensors along highways for sending a signal and alerting said truck talk safety device when the truck approaches the runaway truck ramp/exit.

2. The safety system to notify drivers of runaway truck ramps and exits of claim 1, wherein said truck talk safety device having a power source including a replaceable battery.

3. The safety system to notify drivers of runaway truck ramps and exits of claim 1, wherein said truck talk safety device having a power source including a rechargeable battery.

4. The safety system to notify drivers of runaway truck ramps and exits of claim 1, wherein said truck talk safety device having a power source hardwired to the truck's electrical system.

5. The safety system to notify drivers of runaway truck ramps and exits of claim 1, wherein said wireless communication channel having a V2I communication channel including a wireless data exchange between said truck talk safety device and said truck ramp sign sensors.

6. The safety system to notify drivers of runaway truck ramps and exits of claim 5, wherein said wireless data exchange is transmitted in real-time.

7. The safety system to notify drivers of runaway truck ramps and exits of claim 6, wherein said wireless data exchange includes a 5.9 GHz frequency band.

8. The safety system to notify drivers of runaway truck ramps and exits of claim 5, wherein said wireless communication channel selected from a group consisting of a Dedicated Short Range Communications (DSRC), a Cellular Vehicle-to-Everything (C-V2X), and a Wi-Fi.

9. A safety system to notify drivers of runaway truck ramps and exits, the safety system comprising:
a truck talk safety device for transmitting information to a driver;
wherein said truck talk safety device mounted to an inside of a cab of a truck;
wherein said truck talk safety device having an audio format for providing information to the driver;
wherein said information includes notice of approaching runaway truck ramp/exit;
wherein said truck talk safety device communicates with one or more truck ramp sign sensors positioned on truck ramp signs installed on the highways via a wireless communication channel;
wherein said truck ramp sign sensors including a runaway truck ramp/exit information signal and sends said information signal to said truck talk safety device for providing said information signal to the driver;
wherein said truck ramp sign sensors having a plurality of said truck ramp sign sensors along highways for sending a signal and alerting said truck talk safety device when the truck approaches the runaway truck ramp/exit;
wherein said truck talk safety device having a wireless transceiver including a cellular network selected form a group consisting of a Bluetooth Low Energy (BLE), a Wi-Fi, and a cellular network; and
further wherein said truck talk safety device having an integrated speaker for providing an audible alert to the driver based on said information received from said truck ramp sign sensors.

10. The safety system to notify drivers of runaway truck ramps and exits of claim 9, wherein said truck talk safety device having a power source hardwired to the truck's electrical system.

11. The safety system to notify drivers of runaway truck ramps and exits of claim 9, wherein said wireless communication channel having a V2I communication channel including a wireless data exchange between said truck talk safety device and said truck ramp sign sensors.

12. The safety system to notify drivers of runaway truck ramps and exits of claim 11, wherein said wireless data exchange is transmitted in real-time.

13. The safety system to notify drivers of runaway truck ramps and exits of claim 12, wherein said wireless data exchange includes a 5.9 GHz frequency band.

14. The safety system to notify drivers of runaway truck ramps and exits of claim 13, wherein said wireless communication channel selected from a group consisting of a Dedicated Short Range Communications (DSRC), a Cellular Vehicle-to-Everything (C-V2X), and a Wi-Fi.

15. A safety system to notify drivers of runaway truck ramps and exits, the safety system comprising:
a truck talk safety device for transmitting information to a driver;
wherein said truck talk safety device mounted to an inside of a cab of a truck;
wherein said truck talk safety device having an audio format for providing information to the driver;
wherein said information includes notice of approaching runaway truck ramp/exit;
wherein said truck talk safety device communicates with one or more truck ramp sign sensors positioned on truck ramp signs installed on the highways via a wireless communication channel;
wherein said truck ramp sign sensors including a runaway truck ramp/exit information signal and sends said information signal to said truck talk safety device for providing said information signal to the driver;
wherein said truck ramp sign sensors having a plurality of said truck ramp sign sensors along highways for sending a signal and alerting said truck talk safety device when the truck approaches the runaway truck ramp/exit;
wherein said truck talk safety device having a wireless transceiver including a cellular network selected form a group consisting of a Bluetooth Low Energy (BLE), a Wi-Fi, and a cellular network;
wherein said truck talk safety device having a microphone for receiving a driver's voice; and
further wherein said wireless transceiver communicating a first said truck talk safety device with at least a second said truck talk safety device.

16. The safety system to notify drivers of runaway truck ramps and exits of claim 15, wherein said truck talk safety device having an integrated speaker for providing an audible alert to the driver based on said information received from said truck ramp sign sensors.

17. The safety system to notify drivers of runaway truck ramps and exits of claim 16, wherein said truck talk safety device having a power source hardwired to the truck's electrical system.

18. The safety system to notify drivers of runaway truck ramps and exits of claim 17, wherein said wireless communication channel having a V2I communication channel including a wireless data exchange between said truck talk safety device and said truck ramp sign sensors.

19. The safety system to notify drivers of runaway truck ramps and exits of claim 18, wherein said wireless data exchange is transmitted in real-time.

20. The safety system to notify drivers of runaway truck ramps and exits of claim 19, wherein said wireless transceiver communicating with a fleet management system for tracking a location of the truck in real-time.
